(19) United States
(12) Patent Application Publication
(10) Pub. No.: US 2024/0274372 A1
(43) Pub. Date: Aug. 15, 2024

(54) ELECTROLYTIC DIRECT ENERGY CONVERTER (EDEC)

(71) Applicants: Frank E Gordon, San Diego, CA (US); Harper John Whitehouse, San Diego, CA (US)

(72) Inventors: Frank E Gordon, San Diego, CA (US); Harper John Whitehouse, San Diego, CA (US)

(21) Appl. No.: 18/435,573

(22) Filed: Feb. 7, 2024

Related U.S. Application Data
(60) Provisional application No. 63/444,779, filed on Feb. 10, 2023.

(51) Int. Cl. H01G 15/00; H01G 7/02; H01G 9/022; H01G 9/045; H01G 11/30

(52) U.S. Cl. CPC H01G 15/00; H01G 7/02; H01G 9/022; H01G 9/045; H01G 11/30

(57) ABSTRACT

Disclosed is an electrolytic direct energy converter (EDEC) having a cell that produces electrical energy based on the dynamics of electrically mobile ions within a gel, fluid or solid state electrolyte that is in electrical contact with a pair of electrodes of the cell. The pair of electrodes are physically separated from one another within an electrolyte such that an electric field is generated therebetween. The motion of the ions in the electrolyte causes more of the positive ions to move to one of the pair of electrodes and more of the negative ions to move to the other one of the pair of electrodes whereby to produce a potential voltage. An external electrical load impedance is electrically connected between the pair of electrodes such that the potential voltage is produced by the cell across the load impedance and a current flows through the load impedance.

### CROSS-REFERENCE TO RELATED APPLICATIONS

This application claims the benefit of U.S. Provisional Patent Application No. 63/444,779 filed Feb. 10, 2023, the content of which is fully incorporated by reference herein.

### FIELD OF THE INVENTION

This invention relates to an electrolytic direct energy converter (EDEC) cell to produce electrical energy based on the ion dynamics within a solid-state, gel, or fluidic electrolyte that surrounds and extends between a pair of electrodes. The EDEC includes means to increase the number of mobile ions within the electrolyte without the requirement for naturally radioactive materials.

### BACKGROUND ART

Patents are known to describe devices for the direct energy conversion to electricity using the radiation produced by materials that are naturally radioactive. Several of these patents, [Brown, Ohmart] describe contact potential difference battery devices. In U.S. Pat. No. 2,876,368 issued Mar. 3, 1959, entitled “Nuclear Electret Battery,” Alexander Thomas contemplates the incorporation of a radioactive source and an electret to make a current producing device. Briefly, the patented electret battery and other devices that use naturally radioactive materials only produce small amounts of electrical energy based on the radioactivity of naturally radioactive source. Increasing the energy output from these devices requires a significant increase in the number of Curies of naturally radioactive materials to provide practical energy levels. For example, U.S. Pat. No. 9,466,401 describes the use of tritium to produce electricity in a nuclear battery model P200 that uses 100 millicuries of tritium to produce 125 microwatts of power. While this device might be adequate to supply power for some applications, to scale up the output to produce 12.5 watts would require 10,000 Curies of tritium radiation.

In U.S. Pat. No. 11,232,880 issued Jan. 25, 2022, entitled “Lattice Energy Conversion Device” Gordon and Whitehouse describe a device that uses a material that is not normally considered to be radioactive to spontaneously ionize a gas wherein the ions are transferred to electrodes to produce a voltage across and a current through an external load impedance.

### SUMMARY OF THE INVENTION

An Electrolytic Direct Energy Converter (EDEC) is disclosed herein that advantageously replaces the radioactive materials required by Thomas and others with materials that produce ions without requiring materials that are normally considered to be radioactive. At the same time, the EDEC of this invention improves the aforementioned lattice energy converter by replacing the gas with a solid-state, gel, or fluidic electrolyte material that may already contain mobile ions and where the number of mobile ions can be further increased by the ionizing radiation produced by materials added to the electrolyte that are not normally considered radioactive. In addition, the EDEC of this invention includes an improved method to harvest the ions from the electrolyte, thereby reducing the number of ions that are lost to recombination. The combination of these improvements has experimentally demonstrated the ability to increase power output over the prior art while retaining the ability to scale up the power output by increasing the surface area of the electrodes without the need for radioactive materials. Furthermore, unlike natural radioactive materials which do not increase their radioactivity when the temperature is increased, the EDEC of this invention has experimentally produced increased output power when the temperature was increased from 20° C. to 80° C. When taken in their entirety, these features also provide means to significantly increase the electrical output power to become a ‘green’ electrical power source for many applications.

The mathematics for the conduction of electricity through an ionized gas, including the effects of the electric field and diffusion of the ions within the gas, has been reported by Riecke, Darrow, Rossi and Staubs, and Tate. A book authored by Darrow entitled, Electrical Phenomena in Gases and published in 1932 provides a comprehensive description. It is an object of this invention to apply these mathematical descriptions to EDEC cell configurations and electrode materials as well as to different electrolyte materials in addition to gas, including some that are not normally considered to be electrically conductive such as pure water at normal temperature and pressures and epoxies that are non-conductors until their temperature is increased e.g., greater than 100° C. Another object of this invention is the application of an electric field such as that provided by electrode materials of different work function, electrets, and/or externally applied voltages in concert with an EDEC cell design to modify or increase the electric field through the electrolyte. Still another object of this invention is the use of materials that are not naturally radioactive to augment the ionization of solid-state, gel, and/or fluidic electrolytes. As will be described in greater detail herein, the combination of these inventive features has demonstrated direct energy conversion to electricity to produce energy without producing problematic greenhouse gases, such as methane and CO₂ or radioactive hazardous waste materials.

The EDEC cell disclosed herein has experimentally demonstrated the ability to harvest and utilize the ions from within a solid-state, gel, and/or fluidic electrolyte to produce electrical energy through an external load without the use of materials that are normally considered to be radioactive. Examples using multiple implementations of our EDEC cells demonstrate: a) experimental results when no electric field is present through the solid-state, gel or fluidic electrolyte other than that spontaneously produced; b) experimental results when an electric field such as that produced by electrodes of different work function, an electret or an externally applied electric field is present; c) experimental results where the solid-state, gel, or fluidic electrolyte includes the use of ionizing materials that are not normally considered to be radioactive to supplement the ions within the solid-state or fluidic electrolyte; and d) combinations of these conditions.

### BRIEF DESCRIPTION OF THE DRAWINGS

FIG. 1 illustrates a preferred embodiment for an Electrolytic Direct Energy Converter (EDEC) cell having a gel electrolyte with particulate of hydrogen occluded palladium (Pd) and being connected to an adjustable load impedance and a digital voltmeter (DVM) to measure the electrical current and power performance of the cell.

FIG. 2 is a plot of the current and power produced as a function of load resistance by the

Electrolytic Direct Energy Converter illustrated in FIG. 1.

FIG. 3 illustrates an alternative embodiment for an Electrolytic Direct Energy Converter cell having electrodes of different work function such as Nickel (Ni) and Aluminum (Al) and a solid-state, gel, or fluidic electrolyte.

FIG. 4 is a plot of the current and power which was calculated by measuring the voltage as

a function of load resistance for the EDEC cell shown in FIG. 3.

FIG. 5 illustrates an alternate embodiment for an Electrolytic Direct Energy Converter cell having two electrodes where one of the electrodes has been co-deposited with Pd that is occluded with hydrogen and a solid-state, gel or fluidic electrolyte.

FIG. 6 is a plot of a load test on the EDEC cell shown in FIG. 5.

FIG. 7 illustrates an alternative embodiment for an Electrolytic Direct Energy Converter cell having two electrodes of the same or similar work functions and a solid-state, gel, or fluidic electrolyte.

FIG. 8 is a plot of the voltage and current produced by the EDEC cell illustrated in FIG. 7 where the electrolyte is a high-temperature epoxy and the cell has two Nickel (Ni) electrodes having the same work function embedded within the epoxy.

FIGS. 9A and 9B show plane and end views of an alternative embodiment for an Electrolytic Direct Energy Converter cell having two wires of different work function which act as electrodes where the cell includes a solid-state electrolyte that has been poled to produce an electret.

FIG. 10 is a plot of the current and power as a function of load resistance for the EDEC cell shown in FIG. 9 wherein the solid-state electrolyte is an epoxy that has been poled to produce an electret.

FIG. 11 illustrates an EDEC cell like that shown in previous figures with the addition of a dielectric material and external electrodes connected to a variable voltage source to modify the electric field strength through the electrolyte to improve ion transfer to the electrodes to increase the power output.

FIG. 12 is a plot of data from the EDEC cell shown in FIG. 11 as a function of the variable voltage applied to the external electrodes to modify the electric field within the electrolyte.

FIGS. 13A and 13B show partial cross sections of a modified electrode structure for an EDEC cell having a pair of electrodes where the space between the electrodes is filled with an electrically insulating material so that one or more of the cells can be immersed in the electrolyte.

FIG. 14 is a plot of voltage produced through a 33 KΩ load resistance as a function of temperature for an EDEC cell having Ni and Al electrodes with a gel electrolyte located between the electrodes.

FIG. 15 illustrates an Electrolytic Direct Energy Converter cell having two electrodes and a capacitor connected between the electrodes by output connections.

FIG. 16 is a plot showing an increase in voltage as energy produced by the cell of FIG. 15 is transferred to the capacitor and the capacitor charges.

### DEFINITIONS

For purposes of this disclosure, in addition to standard scientific definitions, the following definitions also apply.

Active material or active electrode: Active materials, also known as hydrogen host materials, are materials that spontaneously generate ions, such as those that could be produced by one or more forms of electromagnetic and/or particulate ionizing radiation when the material is occluded with hydrogen or its isotopes. Active materials are not required to be materials that are normally considered to be radioactive. An active material may be comprised of bulk materials, materials that are deposited onto one or more of the electrodes and/or deposited on an intermediate structure such as a screen positioned between the electrodes, nanoparticles or microparticles, clusters of nanoparticles or microparticles that are occluded with hydrogen or isotopes of hydrogen wherein the energy of the lattice structure in combination with the hydrogen that is occluded in the lattice structure of the active hydrogen host material leads to the generation of ions. The active material or hydrogen host material may be physically deposited by co-deposition from an aqueous solution on one or more electrodes or by mixing an active particulate material into the electrolyte. Multiple materials such as Pd or Ni black, Pd or Ni sponge, bulk Pd, electrodeposited iron and multiple particulates of active materials as well as multiple procedures in addition to co-deposition such as ion-implantation, sputtering, and vapor deposition can be used to prepare an active material. During co-deposition of Pd onto an electrode from an aqueous electrolyte, some of the active Pd particulate separates from the electrode during the co-deposition process and it settles to the bottom of the solution where the active particulate can be collected and mixed into a solid state, gel, or fluidic electrolyte to increase the ionization of the electrolyte. Several techniques are known to have successfully produced active materials that generate ions.

Cell: A basic cell is a combination of electrodes, electrode structures, and an electrolyte configured such that one or more cells form an Electrolytic Direct Energy Converter (EDEC) device and/or its physical implementations wherein the electrode materials react electro-physically but are not required to react electro-chemically with the electrolyte such as zinc and the hydroxyl ion. When an external load impedance is connected between the electrodes, the cell produces a voltage across and a current through the external load impedance.

Contact potential difference (CPD) or Volta potential: Contact potential difference or Volta potential is the voltage difference in work functions between physically separated different materials or different surface conditions when the materials are in electrical contact. Contact potential difference between electrodes can provide an electric field wherein positive and negative ions in the electrolyte migrate to electrodes comprised of materials of different work functions.

Contact: Contact includes physical, electrical, and fluidic contact in and between the components of a cell.

Electrolytic Direct Energy Converter (EDEC) device: An EDEC is a device for the production of electricity. EDEC devices may include multiple cells connected in series, parallel, or a combination thereof to increase voltage and current available to deliver when connected to an external load impedance.

Electrode: An electrode is a conductor through which electricity enters or leaves an object, substance, or region. Electrodes may include active materials that have different work functions. Within the EDEC cell, one or more electrodes may form a pair to transfer the ionic charge from an electrolyte to an external electrical load impedance.

Electrolyte: An electrolyte is a medium containing positively and negatively charged ions that is electrically conducting by the diffusivity and the thermal and electrical mobility of the ions. Electrolytes may include solid, solid-state, gel, or fluidic mediums, active materials and various additives or active structures to increase the number of ions within the electrolyte, thereby increasing the conductivity of the electrolyte. Electrolytes may also include materials which self-ionize such as water, ethylene- and propylene-glycol.

Electrode structure: An electrode or a combination of electrodes that may be electrically interconnected and may include perforations, apertures, or open areas such as but not limited to a mesh, screen, comb, grid, or perforated plates for the passage of an electrolyte and/or radiation.

Electrical contact: As used herein, electrical contact includes contact between an electrode and the electrolyte to facilitate the transfer of charge from the electrolyte to the electrodes. When the electrolyte containing hydrogen is in contact with active hydrogen host materials, hydrogen may diffuse into and be occluded in the active material to maintain the ability to generate ions.

Flux: The rate of flow of ions or charge through the electrolyte or the generation of ions by the hydrogen host material.

Fluidic: Fluidic is an adjective that pertains to a fluid such as a liquid, gel, or a gas.

Hydrogen: As used herein, hydrogen includes hydrogen gas, its atoms, and ions as well as the isotopes and ions thereof such as deuterium gas, its atoms, and deuterium ions.

Hydrogen host materials: Hydrogen host materials include materials and alloys of materials that may form a metal hydride containing hydrogen by well-established processes known as diffusion, loading, charging, or hydrogenation of hydrogen into the hydrogen host material wherein the hydrogen is occluded interstitially within the lattice structure of the hydrogen host material, within vacancies, within super-abundant vacancies, intergranular, or within crystal dislocations, defects, and cracks. Hydrogen also will diffuse, deload or dehydrogenate out of the hydrogen host material. (“Molecular Dynamics Studies of Fundamental Bulk Properties of Pd Hydrides for Hydrogen Storage,” X. W. Zhou et. al., Journal of Physical Chemistry C, Oct. 18, 2016). A few examples of hydrogen host materials include iron, Pd, Ni, titanium and alloys and combinations of these materials and others such as PdAg and NiTiNOL (NiTi). Hydrogen host materials may also include materials into which hydrogen diffuses but does not form a metal hydride at normal temperatures and pressures. (“Diffusion in Solids, Fundamentals, Methods, Materials, Diffusion-Controlled Processes,” H. Mehrer, 2007). Hydrogen host materials may include bulk and/or deposited materials, sponge-like forms such as iron sponge, Pd black and Ni black, as well as nanoparticles and microparticles and clusters of nanoparticles and microparticles of hydrogen host materials. The use of the term specially prepared hydrogen host materials includes materials with lattice features such as vacancies, super-abundant vacancies, cracks and other material defects wherein the hydrogen host material may be occluded with hydrogen such that it is capable of producing ionizing radiation. Hydrogen host materials that generate ions are also referred to herein as “active” materials.

Ions: Ions include electrons, charged atoms, charged molecules, charged clusters of molecules, and charged particulate clusters of molecules.

Mobile ions: Ions whose thermal agitation (motion) is not restricted to a fixed location, (such as vibration in place like the ions in a crystal) but can translate from one location to another location under the influence of temperature (random Brownian motion), concentration gradients (diffusion) or electric fields (drift).

Open-circuit potential difference or voltage: The ‘open-circuit’ potential difference, Δϕ, or voltage, V_{oc}, is the voltage between two electrodes measured by an instrument such as a digital voltmeter (DVM) having a high internal impedance. A typical value of the DVM resistive component, R, of the impedance is 10 megohm. The greater the resistance R, the closer the measured voltage is to the ‘open-circuit’ potential difference, V_{oc}=Δϕ, or voltage between the electrodes.

Work Function: The electron work function ϕ is a measure of the minimum energy to extract an electron from the surface of a solid e.g., ϕ: Pd polycr(yastal) 5.22 eV, Zn polycr 3.63 eV (https://public.wsu.edu/˜pchemlab/documents/Work-functionvalues.pdf.). The work function of a material may change due to changes at the surface of the material such as those caused by oxidation, contamination, and the interaction of ionizing radiation or ions with the surface.

Working electrode or material: As used herein, the term “working electrode” or “specially prepared working electrode” refers to the electrode that may be comprised in whole or in part of active material. A working electrode or material becomes “active” when it is generating ions. The working electrode or material may be either the anode or cathode of an electrical circuit depending on the direction of the flow of the electrons or, it may be neither the anode nor the cathode of an electrical circuit and does not need to be physically connected, such as by a wire, to other components of an electrical circuit.

### DESCRIPTION OF THE PREFERRED EMBODIMENT

For the purpose of promoting an understanding of this invention, several embodiments are described to demonstrate some of the functions, features, and implementations of the Electrolytic Direct Energy Converter (EDEC) as well as selected experimental data and supporting analysis from the described embodiments. It will nevertheless be understood that no limitation of the scope of this invention is intended by the selected embodiments. Any alterations and further modifications in the described embodiments such as different working electrode alloys and hydrogen host materials, different electrode preparations such as sputtering and other deposition techniques as well as other metallurgical processes, different electrolytes, different cell geometries and configurations, as well as any further applications of the concepts of the invention as described herein are contemplated as would normally occur to one skilled in the art to which the invention relates. It is also recognized that the ions generated by the active material can be substituted for the ionizing radiation produced by radioactive materials in many applications such as the nuclear or atomic battery designs.

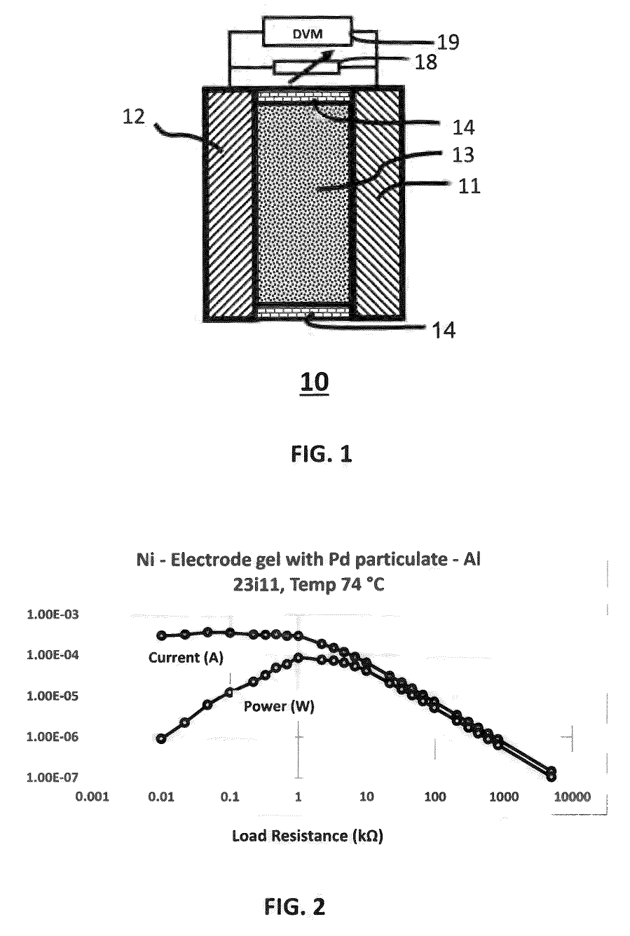

Referring now to the drawings, FIG. 1 illustrates one embodiment for an Electrolytic Direct Energy Converter (EDEC) cell 10 comprised of electrodes 11 and 12 having different work functions to thereby produce a small electric field through the electrolyte. A self-ionizing gel electrolyte 13 that has an active hydrogen host material such as Pd particulate that is occluded with hydrogen is mixed into the electrolyte so as to lie in electrical contact with electrodes 11 and 12. Electrically insulating seals 14 can be used to physically separate the electrodes and retain the gel electrolyte 13 between the electrodes. For this embodiment, electrodes 11 and 12 are comprised of materials with different work functions thereby producing a small electric field through the electrolyte.

In order to measure the performance of the EDEC cell 10, a separate, external load resistance 18, adjustable from 10 MΩ to 10 Ω with multiple intermediate steps, is connected to measure the voltage as a function of load resistance by a DVM 19. This information can be used to calculate the current through the load resistance and the power being produced by the Electrolytic Direct Energy Converter cell 10. Not shown in FIG. 1 is an optional external source of heat such as solar radiation, waste or low-grade heat to increase thermal energy, ion mobility, and ion diffusivity of the electrolyte and thereby increase ion dynamics and cell performance. Also not shown is an optional magnet or source of magnetic field to influence the lattice dynamics of the working electrode and the properties of the occluded hydrogen such as its spin alignment and orientation. A magnetic field can also influence the motion of ions within a gas. It should be recognized that the addition of an electric field can influence both the occlusion of hydrogen and the dynamics of the ions within the electrolyte and thereby alter the flux of charge that is transferred to the electrodes resulting in increased production of voltage and current.

FIG. 2 is a plot of the calculated current and power produced during a load test of the Electrolytic Direct Energy Converter cell 10 illustrated in FIG. 1. Although multiple materials can be used for the electrodes and the electrolyte, the materials that produced this data included one Ni electrode and one Al electrode. The gel electrolyte 13 is of the kind that is typically used in medical procedures to achieve good electrical contact between human skin and a medical instrument. When particulate of active material, (e.g., palladium) is occluded with hydrogen, the palladium is mixed into the electrolyte to augment the ions in the self-ionizing gel electrolyte, whereby the cell performance improves.

One way to characterize electrical power supplies is to measure open circuit voltage and short circuit current. In the case of the Electrolytic Direct Energy Converter cell 10 herein disclosed, a 10 MΩ load resistance was used to measure the ‘open circuit’ voltage, and a 10 Ω load resistance was used to measure the ‘short circuit’ current. By measuring the voltage produced through intermediate resistance values, it is possible to calculate the current and power delivered to an external load (i.e., load resistance 18) as a function of resistance and temperature. It may be appreciated from FIG. 2 that the cell 10 produced a peak current of 3.62×10⁻⁴ amps (362 microamps) and a maximum power of 8.41×10⁻⁵ watts (84.1 microwatts). The surface area of the electrodes 11 and 12 was approximately 16 square centimeters resulting in approximately 5.25 microwatts per square centimeter.

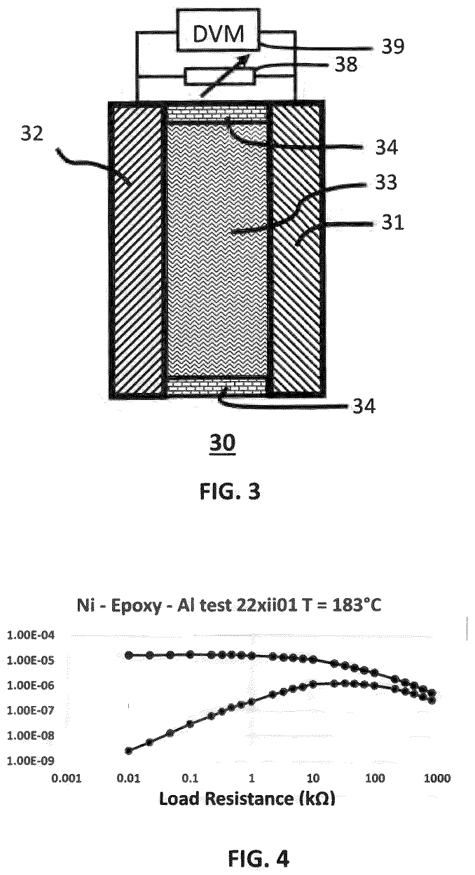

FIG. 3 of the drawings illustrates an alternative embodiment for an Electrolytic Direct Energy Converter cell 30 comprised of electrodes of different work function such as a Ni electrode 31 and an Al electrode 32 with a solid-state electrolyte 33 that includes positive and negative ions that are mobile and subject to diffusion between and in electrical contact with the electrodes. If necessary, electrically insulating seals 34 may be used to physically separate the electrodes and retain the solid-state electrolyte 33 between the electrodes. For this embodiment, electrodes 31 and 32 have different work functions, thereby producing a small electric field through the electrolyte. Cell 30 includes an electric field through the solid-state electrolyte 33 that is produced by the difference in work functions and the diffusion of ions of different mobilities within the electrolyte. When an external load resistance 38 is connected to the EDEC cell 30 between the electrodes 31 and 32 and in parallel with a DVM 39, current flows through the load. By adjusting the load resistance 38 and measuring the voltage by the DVM 39 as a function of load resistance, it is possible to calculate the current produced through the load and the power produced by the EDEC cell.

FIG. 4 shows a plot of the calculated current and power produced by the cell 30 shown in FIG. 3. The current and power was calculated based on the measured voltage as a function of load resistance. For this experiment, one electrode was a 4-inch-long Ni wire and the other was a 4-inch long Al wire with both wires separated and embedded in high temperature epoxy. The temperature at the time of this test was 183° C. which is above the temperature where high temperature epoxies have demonstrated the ability to produce mobile ions. The maximum power produced during this test was 1.2×10⁻⁶ watts.

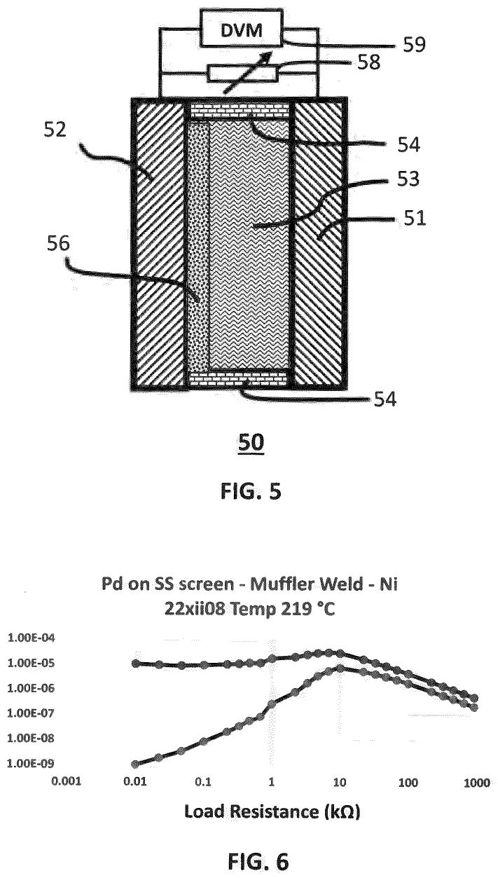

FIG. 5 illustrates another embodiment for an Electrolytic Direct Energy Converter cell 50 having two electrodes 51 and 52 with a solid-state, gel or fluidic electrolyte 53 that includes ions that are mobile and subject to diffusion between and in electrical contact with the electrodes. Electrically insulating seals 54, separate the electrodes and retain the gel or the fluidic electrolyte between and in electrical contact with the electrodes. For this embodiment, electrodes 51 and 52 are materials having different work functions. Electrode 52 is also co-deposited with an active material such as palladium that is occluded with hydrogen 56. Electrodes co-deposited with palladium occluded with hydrogen have demonstrated the ability to generate ions which will further increase the density of ions within the self-ionizing solid-state, gel, or fluidic electrolyte. When an external load resistance 58 is connected between the electrodes in parallel with a DVM 59, current flows through the load. By adjusting the load resistance and measuring the voltage with the DVM as a function of load resistance, it is possible to calculate the current produced through the load and the power produced by the EDEC cell 50.

FIG. 6 of the drawings illustrates a plot of a load test on the Electrolytic Direct Energy Converter shown in FIG. 5 wherein one electrode (e.g., 52) was a stainless-steel screen that was co-deposited with Pd occluded with hydrogen 56, and the other electrode 51 was an nickel wire. An epoxy known commercially as Muffler Weld™ served as the solid-state electrolyte 53. As the plot of FIG. 6 indicates, the peak power was 6.77×10⁻⁶ watts and the peak current was 2.76×10⁻⁵ amps. The area of the stainless-steel screen electrode 51 was approximately 3 square centimeters meaning that the cell 50 produced more than 2 microwatts per square centimeter. This test was conducted at a temperature of 219° C. because the aforementioned epoxy electrolyte 53 will not act like an electrolyte until it is over 100° C.

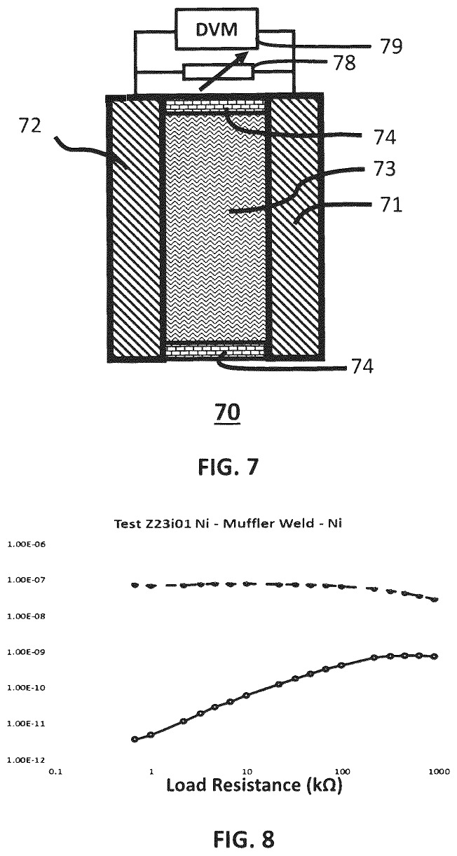

FIG. 7 illustrates another embodiment for an Electrolytic Direct Energy Converter cell 70 having a pair of electrodes 71 and 72 with a solid-state, gel, or fluidic electrolyte 73 that includes ions that are mobile and subject to diffusion between and in electrical contact with the electrodes. If necessary, electrically insulating seals 74 separate the electrodes and retain the solid state, gel, or fluidic electrolyte 73 between the electrodes 71 and 72. Unlike the EDEC cells 10, 30 and 50 of FIGS. 1, 3 and 5, the electrodes 71 and 72 of cell 70 are the same material or materials of equal work function. Even in the absence of a difference in work function, the positive and negative ions within the electrolyte will diffuse at different rates and produce a small voltage between electrodes 71 and 72. When an external load resistance 78 is connected between the electrodes 71 and 72 in parallel with a DVM 79, current flows through the load. By adjusting the load resistance 78 and measuring the voltage with the DVM as a function of load resistance, it is possible to calculate the current produced through the load and the power produced by the EDEC cell 70.

FIG. 8 illustrates a plot of the voltage and current produced by the cell 70 shown in FIG. 7 wherein the electrolyte 73 was a high-temperature epoxy with two nickel electrodes of the same work function embedded within the epoxy. As shown in FIG. 8, in the absence of a work function difference, a small voltage and current produced only 7.90×10⁻¹⁰ watts of power as a function of load resistance. The temperature for this test was 183° C. These results are several orders of magnitude lower than the other cell embodiments where even a small electric field was produced by electrodes of different work functions.

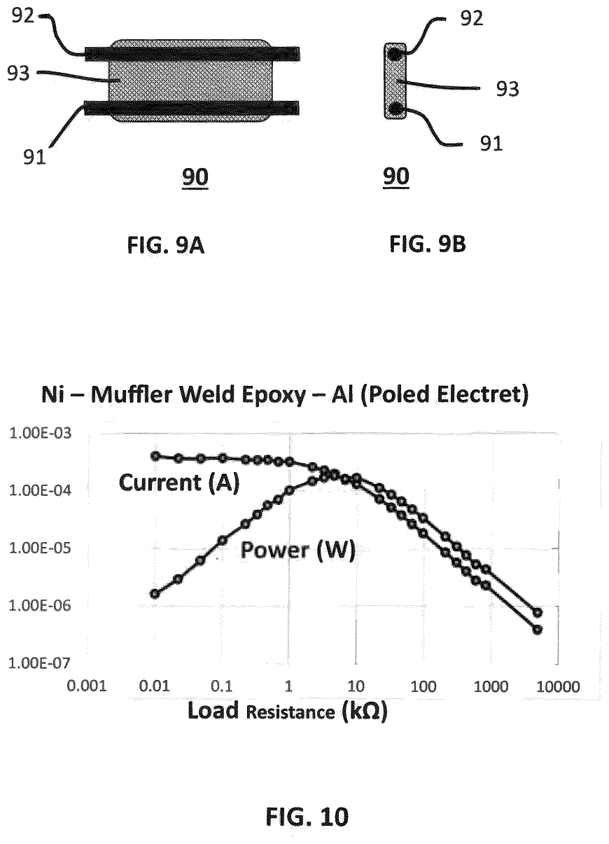

FIGS. 9A and 9B of the drawings illustrate plane and end views for an Electrolytic Direct Energy Converter cell 90 having two wires serving as electrodes 91 and 92 of different work function. For this embodiment, electrode 91 is an aluminum wire with a low work function and electrode 92 is a nickel wire with a higher work function. The electrolyte 93 surrounding and extending between the electrodes 91 and 92 is the previously mentioned epoxy known in the trade as Muffler Weld™. While the epoxy electrolyte 93 is curing, a 24-volt potential was applied to the electrodes with the lower work function electrode 91 being at ground and the higher work function electrode 92 being at +24 volts. After the epoxy had cured and the power supply voltage was removed, a voltage in excess of 1 volt was measured between the electrodes which was greater than similar epoxy experiments, indicating that the epoxy electrolyte 93 had been poled, becoming an electret. Different solid-state electrolytes can be poled to produce an electret.

FIG. 10 of the drawings shows a plot of the current and power as a function of load resistance for an Electrolytic Direct Energy Converter cell 90 wherein the Muffler Weld™ epoxy electrolyte 93 had been poled to produce an electret with the Ni wire electrode 92 positive and the Al wire electrode 91 negative. The electrodes 91 and 92 were approximately 2 mm apart and 10 cm long. The peak power for this test was 2.77×10⁻⁴ Watts (27.7 microwatts), and the surface area of the electrodes was estimated to be approximately 4 square centimeters resulting in a power of approximately 7 microwatts per square centimeter.

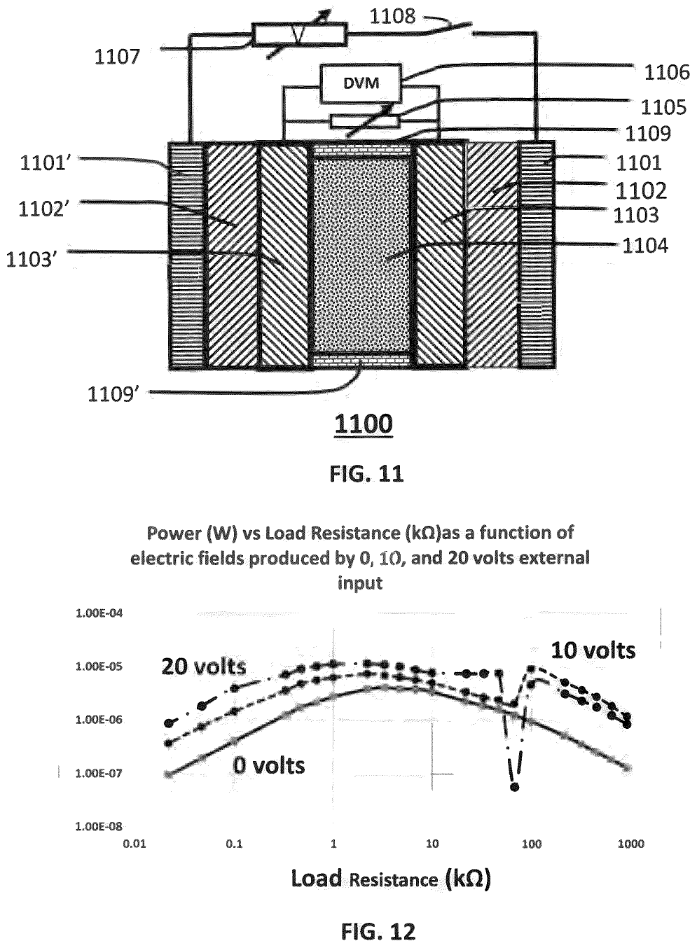

FIG. 11 of the drawings illustrates an EDEC having a cell 1100 that incorporates a controllable electric field to increase the power output. Electrode 1101 lies on a high dielectric material 1102, or a very thin low dielectric material, that forms a capacitor when matched with similar components 1101′ and 1102′ on the opposite side of the EDEC. A variable voltage source 1107 is connected through a switch 1108 to maintain the charge on the capacitor and modify the electric field in an electrolyte 1104 located at the center of the capacitor. A pair of inner electrodes 1103 and 1103′ lie at opposite sides of the electrolyte 1104. Electrodes 1103 and 1103′ have different work functions and may also be comprised in part of an active material. The electrolyte 1104 that may include an active material such as Pd—H particulate to increase the number of ions lies in contact with the electrodes. A variable external electrical load impedance 1105 is connected between the inner electrodes 1103 and 1103′.

In order to calculate the power being produced by the EDEC cell 1100, a digital voltmeter 1106 is connected in parallel with the variable electrical load impedance 1105. By measuring the voltage as a function of load impedance, it is possible to calculate the current produced through the load impedance 1105 and the power produced by the EDEC cell 1100 as a function of load impedance. If required to contain the electrolyte 1104, a non-electrically conductive material 1109 and 1109′ may be positioned between the inner electrodes 1103 and 1103′. The electric field produced through the electrolyte will increase the velocity of the ions within the electrolyte so there is less time for them to recombine, such that a majority of the positive ions move to and transfer their charge to one of the inner electrodes and a majority of the negative ions move to and transfer their charge to the other inner electrode, thus increasing the current available to the external load impedance.

FIG. 12 of the drawings shows a plot of data from the EDEC cell 1100 having an externally controllable electric field produced through the electrolyte 1104 between the inner electrodes 1103 and 1103′. As this data shows, as the electric field is increased, the power output initially increases. However, due to nonlinear dynamics of the ions within the electrolyte, power output can increase or decrease over small changes in electric field strength as shown. Other cell parameters include electrode separation distance, temperature, and ion density. These parameters can be adjusted to optimize power output.

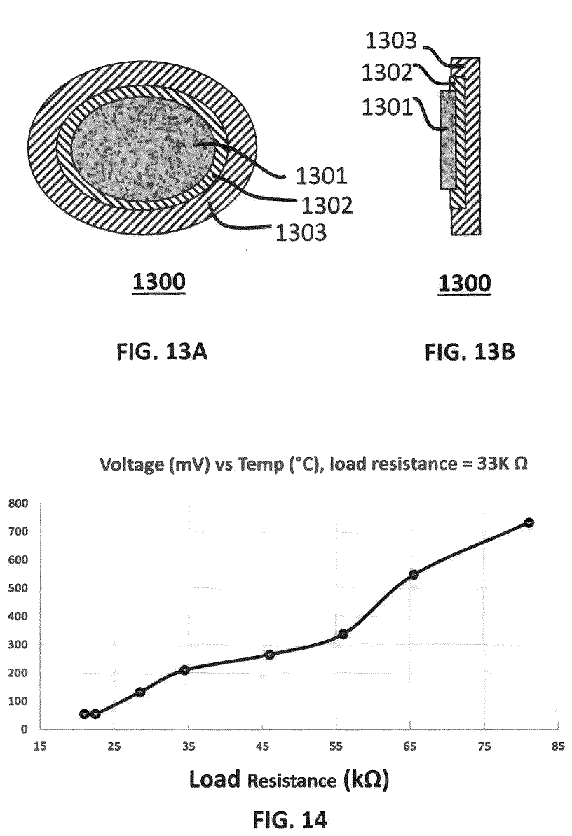

FIGS. 13A is a plan view and 13B is a section view of the drawings to illustrate an EDEC cell assembly 1300 where one electrode 1301 with high work function such as Ag is separated from the low work function counter electrode 1303 by an electrically insulating material 1302. Wires (not shown) connected to the two electrodes 1301 and 1303 provide electrical connection to the assembly 1300 in order to conduct the current and voltage to an external load impedance not shown. The entire electrode and insulating material assembly 1300 is immersed and in fluidic contact with an electrolyte not shown. Multiple cells may be immersed into a container of electrolyte. Care must be taken in the selection of the electrolytes and electrodes to avoid electrochemical reactions with each other.

FIG. 14 of the drawings shows a plot of the voltage produced through a 33 KΩ load resistance as a function of temperature for an EDEC cell comprised of Ni and Al electrodes and a gel electrolyte extending between the electrodes. As shown in the plot, as the temperature slowly increased over a 7-hour period from 21° C. to 81° C., the voltage increased from 55 mV to 728 mV and the power being produced also increased from 1.6 microwatts to 22 microwatts. The ability to increase cell output with modest increases in temperature is another opportunity to scale up the cell power output that is not available to devices that use radioactive materials and do not respond to modest increased temperatures.

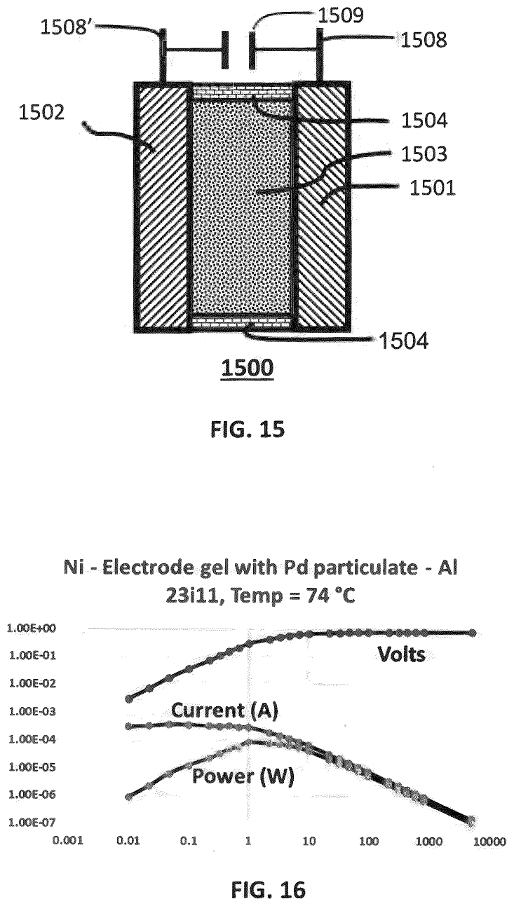

FIG. 15 of the drawings illustrates an embodiment for an Electrolytic Direct Energy

Converter (EDEC) cell 1500 comprised of electrodes 1501 and 1502 having different work functions to thereby produce a small electric field through an electrolyte 1503 between the electrodes. The electrolyte 1503 is a self-ionizing gel that has an active hydrogen host material such as Pd particulate that is occluded with hydrogen and mixed into the electrolyte so as to lie in electrical contact with electrodes 1501 and 1502. Electrically insulating seals 1504 can be used to physically separate the electrodes and retain the gel electrolyte 1503 therebetween. For this embodiment, electrodes 1501 and 1502 are comprised of materials with different work functions thereby producing a small electric field through the electrolyte.

In order to store the energy produced by the EDEC cell 1500, a capacitor 1509 is connected to the electrodes 1501 and 1502 by output connections 1508 and 1508′. In addition to providing energy storage, this cell embodiment will continuously replenish capacitor leakage current so that the energy is available for use on demand. An additional application of the cell 1500 of FIG. 15 is to provide intermittent current and power requirements for multiple applications such as powering light emitting diodes (LEDs).

FIG. 16 of the drawings is a plot showing that as the energy produced by the EDEC is transferred to the capacitor, the voltage increases as the capacitor charges. The energy produced by the EDEC is now stored by the capacitor where it becomes available for use on demand for many applications.

1. An electrolytic direct energy converter (EDEC) adapted to be connected to an electrical load impedance and having a cell that produces a potential difference voltage and a current when the cell is connected to the electrical load impedance, said EDEC cell comprising:
an electrolyte material containing positive and negative mobile ions; and
a pair of electrodes having different work functions, said pair of electrodes being physically separated from one another and lying in electrical contact with said electrolyte,
said electrical load impedance to be electrically connected between said pair of electrodes, whereby a charge difference is created in said electrodes and an electric field is created within the electrolyte such that the motion of the positive and negative mobile ions of said electrolyte causes a majority of the positive ions of said electrolyte to move to one electrode of the pair of electrodes and a majority of the negative ions of said electrolyte to move to the other electrode of said pair of electrodes, whereby the potential difference voltage is produced by said cell across the electrical load impedance and the current produced by said cell flows through the electrical load impedance.

2. The EDEC recited in claim 1, wherein the electrolyte material of said cell is one of a gel, fluid, or solid-state material.

3. The EDEC recited in claim 2, wherein the solid-state material of said electrolyte material is an epoxy, said pair of electrodes being in electrical contact with said epoxy.

4. The EDEC recited in claim 1, wherein at least one electrode of the pair of electrodes of said cell has an active material deposited thereon.

5. The EDEC recited in claim 4, wherein said active material is palladium that is occluded with hydrogen.

6. The EDEC recited in claim 1, wherein the electrolyte material of said cell includes an active particulate material.

7. The EDEC recited in claim 6, wherein the active particulate material of said electrolyte material is palladium particulate that is occluded with hydrogen.

8. The EDEC recited in claim 1, wherein the electrolyte material of said cell includes a non-particulate active material.

9. The EDEC recited in claim 1, wherein one of the pair of electrodes of said cell is comprised in whole or in part of a higher work function material than the other one of said pair of electrodes which is comprised in whole or in part of a lower work function material.

10. The EDEC recited in claim 9, wherein the higher work function electrode material is nickel and the lower work function electrode material is aluminum.

11. The EDEC recited in claim 9, wherein the electrolyte material is a solid state material and the pair of higher work function and lower work function material electrodes of said cell are responsive to a voltage applied therebetween so as to cause the solid-state material to become an electret.

12. The EDEC recited in claim 1, wherein one of the pair of electrodes of said cell is a stainless steel screen that is deposited with palladium that is occluded with hydrogen and the other one of the pair of electrodes is comprised of a different work function material.

13. The EDEC recited in claim 1, wherein the pair of electrodes of said cell have the same or substantially similar work function.

14. The EDEC recited in claim 1, wherein the pair of said electrodes of said cell have respective electrical output connections.

15. An electrolytic direct energy converter (EDEC) having a cell that produces a voltage and a current, said cell comprising:
an electrolyte material containing positive and negative mobile ions; and
a pair of electrodes having different work functions and lying in electrical contact with said electrolyte, said pair of electrodes being physically separated from one another and having respective electrical output connections.

16. The EDEC cell recited in claim 15, wherein said electrical output connections provide electrical conductivity to said pair of electrodes.

17. An electrolytic direct energy converter (EDEC) having a cell that produces a potential difference voltage and a current when said cell is connected to an external circuit, said cell comprising:
an electrolyte material containing positive and negative mobile ions;
a pair of electrodes having different work functions and lying in electrical contact with said electrolyte, said pair of electrodes being physically separated from one another; and
a capacitor connected between said pair of electrodes, whereby the potential difference voltage and the current is produced by said cell and stored in the said capacitor for energy release on demand.

18. The EDEC recited in claim 17, wherein the electrolyte material of said cell is one of a gel, fluid, or solid-state material.

19. The EDEC recited in claim 17, where the capacitor of said cell is an electrolytic capacitor.
